(19) United States
(12) Patent Application Publication
(10) Pub. No.: US 2011/0307500 A1
(43) Pub. Date: Dec. 15, 2011

(54) METHOD AND APPARATUS FOR MANAGING ASPECT AND ASPECT TRIGGER

(75) Inventors: Kepeng LI, Shenzhen (CN); Rong Deng, Shenzhen (CN); Wenjie Zhu, Shenzhen (CN)

(73) Assignee: HUAWEI TECHNOLOGIES CO., LTD., Shenzhen (CN)

(21) Appl. No.: 13/172,201

(22) Filed: Jun. 29, 2011

Related U.S. Application Data
(63) Continuation of application No. PCT/CN2009/076376, filed on Dec. 31, 2009.

(30) Foreign Application Priority Data
Dec. 31, 2008 (CN) 200810242229.0

(51) Int. Cl. G06F 17/30

(52) U.S. Cl. 707/755; 707/E17.014

(57) ABSTRACT

The present invention discloses a method and an apparatus for managing an aspect and an aspect trigger. The method for managing an aspect and an aspect trigger includes the following steps: the apparatus for managing an aspect and an aspect trigger receives a request message that carries a definition and a storage path of an aspect and/or aspect trigger, where the aspect is an abstraction of one or more information elements or represents one or more types of information elements needed to be obtained, and the aspect trigger represents to perform a corresponding trigger action when a specific aspect fulfills a preset condition; and the apparatus for managing an aspect and an aspect trigger parses the request message, and creates, according to the storage path, a document that includes the definition of the aspect and/or aspect trigger.

### CROSS-REFERENCE TO RELATED APPLICATIONS

This application is a continuation of International Application No. PCT/CN2009/076376, filed on Dec. 31, 2009, which claims priority to Chinese Patent Application No. 200810242229.0, filed on Dec. 31, 2008, both of which are hereby incorporated by reference in their entireties.

### FIELD OF THE INVENTION

The present invention relates to the communication field, and in particular, to a method and an apparatus for managing an aspect and an aspect trigger.

### BACKGROUND OF THE INVENTION

Presence information in a presence service includes availability information, information about willingness of participating in the service, mood, activity, network state, and device capability. A presence information document is represented in a Presence Information Data Format (PIDF). That is, the presence information is divided into three types: service-related information, presentity-related information, and device-related information.

After a presence client receives a presence information document, the presence information in the presence information document needs to be parsed according to the definition of the presence information elements and the processing rules (for example, the conflicting elements are discarded or selected according to the timestamp). That is, a watcher is responsible for parsing the presence information document, and selecting and filtering the correct presence information. The conventional presence service provides no mechanism for executing general logic processing. Each watcher needs to perform repeat processing separately even if the same presence information document is received. Therefore, to relieve the load of processing presence information on the watcher, a Presence Access Layer (PAL) is introduced into the presence service as an abstract layer to simplify the presence service. Specifically, the PAL receives the presence information document sent by the presence server, consolidates and calculates the presence information according to certain rules, and returns a simple result to the watcher. In this way, the operations of the watcher are simplified, and the traffic of interactions between the watcher and the presence server is reduced. Moreover, a method to implement general logics for processing presence information is provided for multiple watchers.

An aspect and an aspect trigger are basic integral elements of the PAL. The definitions of such elements are closely related to the implementation of the PAL service. An aspect in the PAL is an abstraction of information. From the perspective of functions, aspects include but are not limited to: information simplification aspects and information indication aspects. An information simplification aspect is used to abstract logics of one or more presence information elements, or logics of presence information elements combined with other information elements (including location information elements and personal basic information elements, etc). That is, the aspect is a result of simplifying the information about this aspect according to certain rules. An information indication aspect is used to instruct the server to return information included in the definition of the aspect. The two types of aspects differ in that: As regards the information simplification aspect, after the server obtains information about the aspect, the server needs to judge the logics of the obtained information according to certain rules to obtain a simplified result, namely, a value of the aspect; as regards the information indication aspect, the server needs to obtain the information about the aspect and return the information to the client without judging the logics of the obtained information, namely, without the need of calculating the value of the aspect. Certainly, the functions of the aspect in the PAL are not limited to such two types, and may be extended as required. From the perspective of definition mode, the aspects in the PAL are classified into two types: system-defined aspect, and user-defined aspect. System-defined aspects are basic and generic aspects defined by the PAL system, for example, “availability” (availability information), and “willingness” (willingness of participating in the service). User-defined aspects are the aspects defined by different users, services, and groups because the PAL supports the customization and extension of the aspects.

Besides, another element “aspect trigger” in the PAL is used to monitor the change of the value of the information simplification aspect to check whether the change fulfills a trigger condition in the aspect trigger. For example, when the aspect changes to a specific value that fulfills the trigger condition, the PAL server performs the corresponding operations, including: sending a notification to the PAL client and triggering the service, that is, sending a service trigger notification to the service engine. Similar to the classification of an aspect, an aspect trigger also includes a system-defined aspect trigger and a user-defined aspect trigger.

### SUMMARY OF THE INVENTION

Embodiments of the present invention aim at managing an aspect and an aspect trigger uniformly, so that a PAL client can implement PAL services more conveniently and that the load on the PAL client can be relieved.

According to one aspect, an embodiment of the present invention provides a method for managing an aspect and an aspect trigger, including:

receiving a request message that carries a definition and a storage path of an aspect and/or aspect trigger, where the aspect is an abstraction of one or more information elements or represents one or more types of information elements needed to be obtained, and the aspect trigger represents to perform a corresponding trigger action when a specific aspect fulfills a preset condition; and

parsing the request message, and creating, according to the storage path, a document that includes the definition of the aspect and/or aspect trigger.

According to another aspect, an embodiment of the present invention provides an apparatus for managing an aspect and an aspect trigger, including:

a receiving unit, configured to receive a request message that carries a definition and a storage path of an aspect and/or aspect trigger, where the aspect is an abstraction of one or more information elements or represents one or more types of information elements needed to be obtained, and the aspect trigger represents to perform a corresponding trigger action when a specific aspect fulfills a preset condition; and

a processing unit, configured to parse the request message, and create, according to the storage path, a document that includes the definition of the aspect and/or aspect trigger.

According to still another aspect, an embodiment of the present invention provides a method for managing an aspect and an aspect trigger, including:

generating a request message that includes a definition and a storage path of an aspect and/or aspect trigger; and

sending the request message to an apparatus for managing an aspect and an aspect trigger on a network side so that the apparatus for managing an aspect and an aspect trigger stores, according to the storage path, the definition of the aspect and/or aspect trigger.

According to still another aspect, an embodiment of the present invention provides an apparatus for processing an aspect and an aspect trigger, including:

a request generating unit, configured to generate a request message that includes a definition and a storage path of an aspect and/or aspect trigger; and

a sending unit, configured to send the request message to an apparatus for managing an aspect and an aspect trigger on a network side so that the apparatus for managing an aspect and an aspect trigger stores, according to the storage path, the definition of the aspect and/or aspect trigger.

According to still another aspect, an embodiment of the present invention provides a system for managing an aspect and an aspect trigger, including:

a PAL server, configured to generate a request message that includes a definition and a storage path of an aspect and/or aspect trigger, and send the request message to an apparatus for managing an aspect and an aspect trigger on a network side so that the apparatus for managing an aspect and an aspect trigger stores, according to the storage path, the definition of the aspect and/or aspect trigger; and

the apparatus for managing an aspect and an aspect trigger, configured to: receive the request message that carries the definition and the storage path of the aspect and/or aspect trigger, where the aspect is an abstraction of one or more information elements or represents an information element needed to be obtained, and the aspect trigger represents a corresponding trigger action to be performed when the aspect fulfills a trigger condition; and parse the request message, and create, according to the storage path, a document that includes the definition of the aspect and/or aspect trigger.

According to still another aspect, an embodiment of the present invention provides a service processing method, including:

receiving a service request that carries an identifier of an aspect and/or aspect trigger;

obtaining, according to the identifier of the aspect and/or aspect trigger, a definition of the aspect and/or aspect trigger from an apparatus for managing an aspect and an aspect trigger on a network side; and

processing services according to the definition of the aspect and/or aspect trigger.

According to still another aspect, an embodiment of the present invention provides a PAL server, including:

a receiving unit, configured to receive a service request that carries an identifier of an aspect and/or aspect trigger;

an obtaining unit, configured to obtain, according to the identifier of the aspect and/or aspect trigger, a definition of the aspect and/or aspect trigger from an apparatus for managing an aspect and an aspect trigger on a network side; and

a service processing unit, configured to process services according to the definition of the aspect and/or aspect trigger.

According to still another aspect, an embodiment of the present invention provides a service processing system, including:

a PAL server, configured to: receive a service request that carries an identifier of an aspect and/or aspect trigger; obtain, according to the identifier of the aspect and/or aspect trigger, a definition of the aspect and/or aspect trigger from an apparatus for managing an aspect and an aspect trigger on a network side; and process services according to the definition of the aspect and/or aspect trigger; and

the apparatus for managing an aspect and an aspect trigger, configured to create a document that includes the definition of the aspect and/or aspect trigger.

The method and the apparatus for managing an aspect and an aspect trigger provided in the embodiments of the present invention manage an aspect and an aspect trigger, so that a PAL client can use PAL services more conveniently, and the load on the PAL client can be relieved.

### BRIEF DESCRIPTION OF THE DRAWINGS

FIG. 1 is a flowchart of a method for managing an aspect and an aspect trigger according to an embodiment of the present invention;

FIG. 2 is a flowchart of an application instance of a method for managing an aspect and an aspect trigger according to an embodiment of the present invention;

FIG. 3 is a flowchart of an application instance of a method for requesting to create a new element or new attribute of an aspect and/or aspect trigger according to an embodiment of the present invention;

FIG. 4 is a flowchart of an application instance of a method for requesting to obtain and create a definition of an aspect and/or aspect trigger according to an embodiment of the present invention;

FIG. 5 is a schematic structural diagram of an apparatus for managing an aspect and an aspect trigger according to an embodiment of the present invention;

FIG. 6 is a flowchart of another method for managing an aspect and an aspect trigger according to an embodiment of the present invention;

FIG. 7 is a schematic structural diagram of an apparatus for processing an aspect and an aspect trigger according to an embodiment of the present invention;

FIG. 8 is a schematic structural diagram of a system for managing an aspect and an aspect trigger according to an embodiment of the present invention;

FIG. 9 is a flowchart of a service processing method according to an embodiment of the present invention;

FIG. 10 is a schematic structural diagram of a PAL server according to an embodiment of the present invention; and

FIG. 11 is a schematic structural diagram of a service processing system according to an embodiment of the present invention.

### DETAILED DESCRIPTION OF THE EMBODIMENTS

To make the objectives, technical solution and merits of the present invention clearer, the following describes the present invention in detail with reference to the embodiments and accompanying drawings. The exemplary embodiments of the present invention and the description thereof are illustrative in nature, and shall not be construed as limitations on the present invention.

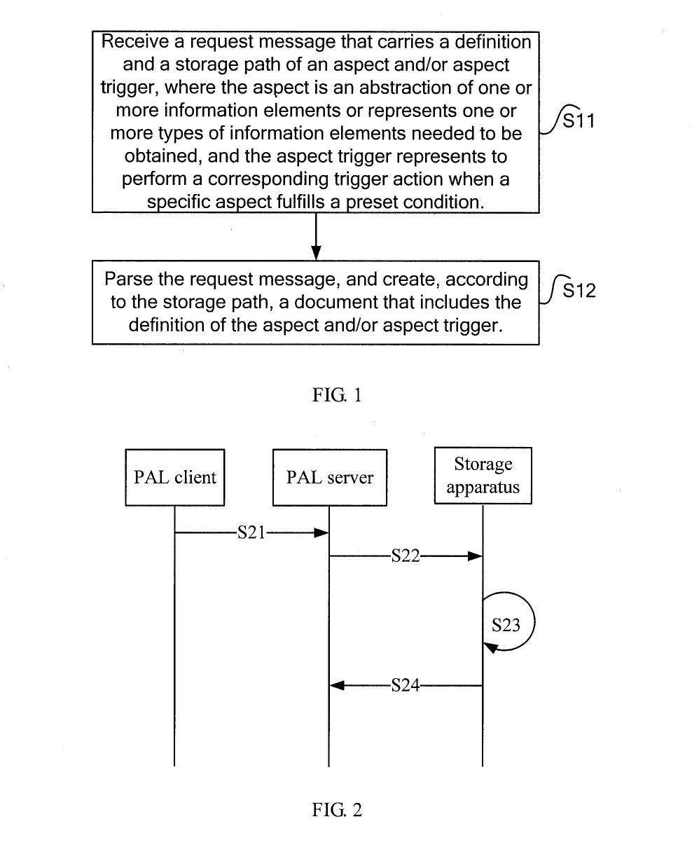

FIG. 1 is a flowchart of a method for managing an aspect and an aspect trigger according to an embodiment of the present invention. The method includes the following steps:

S11: Receive a request message that carries a definition and a storage path of an aspect and/or aspect trigger, where the aspect is an abstraction of one or more information elements or represents one or more types of information elements needed to be obtained, and the aspect trigger represents to perform a corresponding trigger action when a specific aspect fulfills a preset condition.

The request message may be sent by a PAL client or a PAL server. Specifically, the request message may be sent through a PUT request in an XML Configuration Access Protocol (XCAP), where XML stands for Extensible Markup Language; the request message is received by an apparatus for managing an aspect and an aspect trigger that stores a definition of the aspect and/or the aspect trigger. The apparatus for managing an aspect and an aspect trigger may be an Aspect XML Document Management Server (XDMS).

The request message includes a name and a storage path of a document to be stored, where the document includes the definition of the aspect and/or aspect trigger.

For example, for the purpose of requesting to store the definition of an aspect trigger, the request message may be a PUT request in the following format:

PUT/pal-aspect/users/sip:user@example.com/triggerdef HTTP/1.1
Host: xcap.example.com
...
Content-Type: application/ pal-trigger +xml
Content-Length: (...)
<trigger-list>
< trigger name=“IM-session on IM-availability”>

<condition>

<changed to=“available”>

<aspect>IM-availability</aspect>

</changed>

</condition>
<action id=“a”>

<service>IM-session</service>

</action>

</ trigger>
<trigger name=“......”>
......
</trigger>
......
</trigger-list>

In the preceding request message, “PUT” indicates that the request uses the PUT method in the Hypertext Transfer Protocol (HTTP); “pal-aspect” is an Application Unique ID (AUID), which is a unique identifier of the application to which the XCAP resource is applied; “/pal-aspect/users/sip:user@example.com/triggerdef/” is a document selector (which uses a path fragment of a sequence to represent the selected document). In this message, the document selector represents the document named “triggerdef” of the user “sip:user@example.com”.

“HTTP/1.1” represents the protocol version; the “Host” header field indicates that the requested resource is an XCAP server; “users/sip:user@example.com” represents an identity of the PAL user, and the message header field specifies the storage address of the aspect trigger definition needed to be stored; and the <trigger> element represents the aspect trigger definition needed to be stored.

In the following example, the PAL client sends a request message through an HTTP PUT command to the apparatus for managing an aspect and an aspect trigger, requesting to create a new document for storing the aspect definition. The request message is as follows:

PUT/pal-aspect/users/sip:user@example.com/aspectdef HTTP/1.1
Host: xcap.example.com
...
Content-Type: application/pal-asepct+xml
Content-Length: (...)
<?xml version=“1.0” encoding=“UTF-8”?>
<aspect-list xmlns=“urn:oma:xml:xdm:aspect-list>

<aspect name=“......”>

<note>......</note>
<result id=“a”>

......

</result>
<result id=“b”>

......
</result>

<aspect>

<aspect name=“......”>

.......

</aspect>

</aspect-list>

In the preceding example, “/pal-aspect/users/sip:user@example.com/aspectdef” is an indication of creating an XML document named “aspectdef” in this path. See the previous example for the meanings of other same elements, which are not repeatedly described here.

S12: Parse the request message, and create, according to the storage path, a document that includes the definition of the aspect and/or aspect trigger.

After receiving the request message, the apparatus for managing an aspect and an aspect trigger parses the path provided in the request header field. For example, if the request is a PUT request, the parsed content includes the storage path and the name of the document needed to be created. Afterward, the document is created in this storage path, and the content of the document is the content indicated in the message body of the PUT request, namely, the definition of the aspect and/or aspect trigger. The name of the document is the document name provided in the header field path, and specifically, the document may be an XML document.

In this embodiment, the dedicated apparatus for managing an aspect and an aspect trigger parses the request message sent by the PAL client or PAL server, and stores the definition of the aspect and/or aspect trigger carried in the request message to the specified storage path in the form of a document, so that the PAL client can use the PAL service more conveniently and that the load on the PAL client can be relieved.

After storing the document, the apparatus for managing an aspect and an aspect trigger may also return a 201 Created response message to the sender of the request message, indicating that the new XML document is created successfully. The response message may be as follows:

HTTP/1.1 201 Created
Etag: “cdcdcdcd”
...
Content-Length: 0

In this embodiment of the present invention, the value of an aspect in the definition of the aspect may depend on a value of a specific information element and/or a value of another aspect.

That is, the aspect also supports nesting. The definition of the aspect may be represented by another aspect, or represented by another aspect and a condition based on a specific type of information.

In the following example, the value of the aspect in the definition of the aspect depends on the value of another aspect:

<aspect name=“name1”>

<note>This aspect is used to indicate......</note>
<result id=“a”>

<sub_aspect name=“name2”>

......(condition based on this aspect)

</sub_aspect>
<sub_aspect name=“name3”>

......(condition based on this aspect)

</sub_aspect>
<value>result1</value>

</result>
<result id=“b”>

<sub_aspect name=“name2”>

......(condition based on this aspect)

</sub_aspect>

<sub_aspect name=“name3”>

......(condition based on this aspect)

</sub_aspect>
<value>result2</value>

</result>
......(other values of the aspect, corresponding to more <result>
elements)

</aspect>

In the preceding example, a <sub_aspect> element is nested in the <aspect> element. That is, the <sub_aspect> element is the subelement of the <aspect> element. The <sub_aspect> element indicates the condition to be fulfilled by the sub-aspects that construct this aspect definition. In the preceding example, the value of the aspect identified as name1 is result1 when the aspects identified as name2 and name3 respectively fulfill the condition based on this aspect. The meanings of other elements and attributes in the definition have been described in the previous example, and are not repeatedly described here.

In this embodiment of the present invention, the aspect and/or aspect trigger may be defined by the system or the user. That is, the apparatus for managing an aspect and an aspect trigger (such as an Aspect XDMS) may receive the aspect and/or aspect trigger that are defined by the system as well as the aspect and/or aspect trigger that are defined by the user.

In another embodiment of the present invention, optionally, the apparatus for managing an aspect and an aspect trigger that stores a definition of the aspect and/or the aspect trigger may also receive other requests that specify the storage path of the requested document. Such requests may be a MODIFY request, a DELETE request, a GET request, and a CREATE request, include new elements and/or new attributes, and may be sent by a PAL client or a PAL server. After receiving the requests, the apparatus for managing an aspect and an aspect trigger needs to find the requested document according to the specified storage path.

1. When the received request is a MODIFY request, the apparatus for managing an aspect and an aspect trigger modifies the definition of the aspect and/or aspect trigger in the document according to the MODIFY request.

Specifically, the PAL client or PAL server sends an XCAP PUT command as a MODIFY request to the apparatus for managing an aspect and an aspect trigger, requesting to modify the existing specific elements or specific attributes in the definition document, or modify the whole definition document. The MODIFY request includes the storage path of the document, or of the element or of the attribute that are needed to be modified, and the modified information.

The following is an example of modifying codes of a request message, and is an indication of substituting the information in the message body for the definition of the aspect trigger identified as “IM-session”.

PUT/pal-aspect/users/sip:user@example.com/triggerdef

/~~/trigger-list/aspect-trigger%5b@name=%22IM-session%22%5d
HTTP/1.1

Host: xcap.example.com
...
Content-Type: application/xcap-el+xml
Content-Length: (...)
<aspect-trigger>

<condition>

<changed to=“available”>

<aspect>IM-availability</aspect>

</changed>

</condition>
<action id=“a”>

<service>IM-session</service>

</action>

</aspect-trigger>

After receiving the MODIFY request, the apparatus for managing an aspect and an aspect trigger parses the path provided in the header field of the MODIFY request. The parsed content includes the storage path and the identifier of the definition document. Afterward, the apparatus for managing an aspect and an aspect trigger finds the specific element or specific attribute needed to be modified in the definition document, and substitutes the specific element or specific attribute carried in the message body of the MODIFY request for the specific element or specific attribute that are needed to be modified in the definition document.

2. When the received request is a DELETE request, the apparatus for managing an aspect and an aspect trigger deletes the definition of the aspect and/or aspect trigger in the document according to the DELETE request.

Specifically, the PAL client or PAL server sends an XCAP DELETE command as a DELETE request to the apparatus for managing an aspect and an aspect trigger, requesting to delete the whole definition document or delete a specific element or specific attribute. The DELETE request includes the storage path of the definition document needed to be deleted. When requesting to delete a specific element, the DELETE request further needs to include an identifier of the specific element or the specific attribute that are needed to be deleted.

The following codes of a DELETE request indicate that a “name” attribute of an aspect identified as “IM-session” is requested to be deleted.

DELETE /pal-aspect/users/sip:user@example.com/aspectdef/~~/aspect-list/aspect

%5b@name=%22IM-session%22%5d/@name HTTP/1.1

Host: xcap.example.com
...

After receiving the DELETE request, the apparatus for managing an aspect and an aspect trigger parses the path provided in the request header field, that is, locates the document, the specific element or the attribute that are needed to be deleted, and then deletes it.

3. When the received request is a GET request, the apparatus for managing an aspect and an aspect trigger sends, according to the GET request, the definition of the aspect and/or aspect trigger included in the document to the requester.

Specifically, the PAL client or PAL server sends an XCAP GET command as a GET request to the apparatus for managing an aspect and an aspect trigger, requesting to obtain the definition of the needed aspect and/or aspect trigger, for example, obtaining the whole definition document or a specific element or attribute in the definition document. The GET request includes the storage path of the definition document needed to be obtained. When obtaining a specific element or attribute in the definition document, the GET request further needs to include an identifier of the specific element or attribute that are needed to be obtained.

After receiving the GET request, the apparatus for managing an aspect and an aspect trigger parses the path provided in the request header field, that is, locates the document, specific element or attribute that are needed to be obtained, and then sends it to the requester.

The following uses an exemplary procedure to describe how the PAL client or PAL server obtains the definition of the needed aspect and/or aspect trigger from the apparatus for managing an aspect and an aspect trigger through the GET method in XCAP.

FIG. 2 is a flowchart of an application instance of a method for managing an aspect and an aspect trigger according to an embodiment of the present invention. In this example, after a PAL server receives a service request from a PAL client, because the service request carries only a name of an aspect, the PAL server needs to first obtain a definition of the aspect from an Aspect XDMS which serves as an apparatus for managing an aspect and an aspect trigger before performing subsequent operations.

S21: A PAL client sends a service request related to the “PoC-availability” aspect to a PAL server. The service request provides only an identifier of the aspect. It is assumed that a Session Initiation Protocol (SIP) Uniform Resource Identifier (URI) of the user corresponding to the PAL client is sip:user@example.com.

Further, the request message also specifies a type of the aspect, namely, whether the aspect is a system-defined aspect or a user-defined aspect. In this way, the Aspect XDMS can locate the definition document to which the aspect belongs conveniently.

S22: The PAL server sends an HTTP GET command to the Aspect XDMS to request the definition of the aspect. The request message includes a storage path and the identifier of the definition of the aspect needed to be obtained, as shown below:

GET/pal-aspect/users/sip:user@example.com/aspectdef/~~/aspect-list/aspect%5b

@name=%22PoC-availability%22%5d HTTP/1.1

Host xcap.example.com

S23: After receiving the request message, the Aspect XDMS parses the request message, and finds, according to the storage path provided in the request message, the corresponding definition document and aspect element.

S24: The Aspect XDMS returns a 200 OK response message that carries the definition of the aspect to the PAL server. The response message is as shown below:

HTTP/1.1 200 OK
...
Etag: “ababab”
Content-Type:application/pal-aspect+xml
Content-Length: (...)
<aspect name=“PoC-availability”>

<note>This aspect is used to indicate if someone is available for PoC.</note>

<result id=“a”>

<prs-elements>

<status>open</status>
<session-participation>closed</session-participation>

</prs-elements>
<value>available</value>

</result>

<result id=“b”>

<prs-elements>

<status>closed</status>
<session-participation>open</session-participation>

</prs-elements>
<value>unavailable</value>

</result>

<aspect>

See the previous example for the detailed procedure of requesting a specific document or a specific attribute, which is not repeatedly described here.

4. When the received request is a CREATE request that includes a new element and/or new attribute of the aspect and/or aspect trigger, the apparatus for managing an aspect and an aspect trigger adds the new element and/or new attribute to the document according to the CREATE request.

Specifically, the PAL client or PAL server sends an XCAP PUT command as a CREATE request to create the new element or new attribute and in a specific location of a certain definition document in the apparatus for managing an aspect and an aspect trigger. The CREATE request includes the storage path of the definition document into which the new element or new attribute needed to be inserted, the location in which the new element or new attribute is inserted, and the new element or new attribute itself.

Further, after receiving the PUT request, the apparatus for managing an aspect and an aspect trigger parses the path provided in the header field of the request. The parsed content includes the document into which the new element or new attribute is to be inserted, and the location in which the new element or new attribute is inserted. Afterward, the apparatus for managing an aspect and an aspect trigger locates the insertion location, and adds to the location the new element or new attribute carried in the message body of the PUT message.

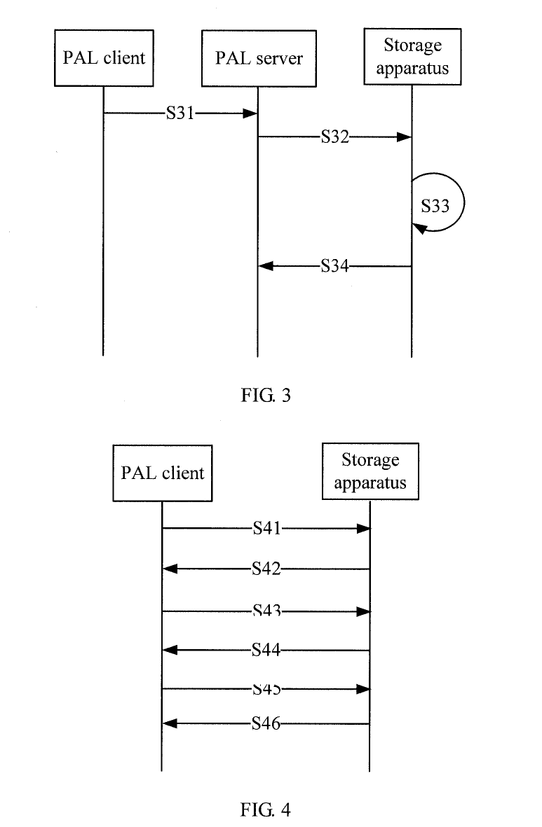

FIG. 3 is a flowchart of an application instance of a method for requesting to create a new element or new attribute of an aspect and/or aspect trigger according to an embodiment of the present invention. In this embodiment, a PAL server requests to add a new element behind the “aspect-trigger” element whose “name” attribute is “IM session” in the Aspect XDMS that serves as an apparatus for managing an aspect and an aspect trigger.

S31: A PAL client sends an Instant Message (IM) service trigger request to a PAL server. The request carries the definition of the aspect trigger. It is assumed that an SIP URI of a PAL user is sip:user@example.com.

S32: The PAL server sends an HTTP PUT command as a request message to the Aspect XDMS, requesting the Aspect XDMS to add a new element behind the “aspect-trigger” element whose “name” attribute is “IM session” in the Aspect XDMS.

The request message is as shown below:

PUT
/pal-aspect/users/sip:user@example.com/triggerdef

/~~/trigger-list/aspect-trigger%5b@name=%22IM-session%22%5d/aspect-trigger%5b@name
=%22PoC-session%22%5d HTTP/1.1

Host: xcap.example.com
...
Content-Type: application/xcap-el+xml
Content-Length: (...)
<aspect-trigger>

<condition>

<changed to=“available”>

<aspect> PoC -availability</aspect>

</changed>

</condition>
<action id=“a”>

<service> PoC -session</service>

</action>

</aspect-trigger>

In the preceding request message, “˜˜” is an identifier for separating a document selector and a node selector (the node selector uses a path fragment of a sequence to identify the XML node (element or attribute) being selected within a document); “trigger-list/aspect-trigger%5b@name=%22IM-session %22%5d/aspect-trigger %5b@name=%22PoC-session %22%5d” indicates that a new aspect trigger element is added behind an existing aspect trigger element, where the “name” attribute of the existing aspect trigger element is “IM session”, and the “name” attribute of the new aspect trigger element is “PoC-session”.

S33: After receiving the request message, the Aspect XDMS parses the request message, and adds a new aspect trigger element carried in the message body behind an existing aspect trigger element, where the “name” attribute of the existing aspect trigger element is “IM session”, and the “name” attribute of the new aspect trigger element is “PoC-session”.

The PAL user may set the rights of the PAL server so that the PAL server is entitled to modify the definition document created by the user. After being authorized by the user, the PAL server adds the definition carried in the request to the definition document.

S34: The Aspect XDMS returns a 200 OK response message to the PAL server to confirm success of adding. The response message is as shown below:

HTTP/1.1 200 OK
Etag: “efefefef”
...
Content-Length: 0

In this embodiment, the apparatus for managing an aspect and an aspect trigger supports modification and deletion of the document stored in the apparatus with respect to the definition of the aspect and/or aspect trigger, supports creation of a new attribute or element, and sends the definition of the aspect and/or aspect trigger to the requester. Therefore, the PAL server or PAL client may manage and use the definition of the aspect and/or aspect trigger flexibly and conveniently, which relieves the load on the client.

FIG. 4 is a flowchart of an application instance of a method for requesting to obtain and create a definition of an aspect and/or aspect trigger according to an embodiment of the present invention. In this embodiment, before a PAL user uses a PAL service, the PAL user wants to view definitions of all aspects stored in an Aspect XDMS that serves as an apparatus for managing an aspect and an aspect trigger, including the system-defined aspects and the user-defined aspects. When the user finds that no aspect meets the current requirement, the user creates a new aspect on the basis of the existing aspect. The method includes the following steps:

S41: The PAL client sends an HTTP GET command as a GET request to the Aspect XDMS, requesting to obtain a definition of an aspect provided by the system and stored on the Aspect XDMS. The request message is as shown below:

GET/pal-aspect/system/aspectdef HTTP/1.1
Host xcap.example.com

S42: The Aspect XDMS parses the GET request, and returns a 200 OK response message to the PAL client. The response message carries an XML document that includes definitions of all aspects provided by the system and stored on the Aspect XDMS. The response message is as shown below:

HTTP/1.1 200 OK
...
Etag: “ababab”
Content-Type:application/pal-aspect+xml
Content-Length: (...)
<?xml version=“1.0” encoding=“UTF-8”?>
<aspect-list xmlns=“urn:oma:xml:xdm:aspect-list>
<aspect name=“......”>

<note>......</note>

<result id=“a”>

......

</result>

<result id=“b”>

......

</result>

<aspect>
<aspect name=“......”>

.......

</aspect>
<aspect name=“......”>

.......

</aspect>

......
</aspect-list>

S43: The PAL client sends an HTTP GET command as a GET request to the Aspect XDMS, requesting to obtain the definitions of all aspects defined by the user and stored on the Aspect XDMS. The request message is as shown below:

GET/pal-aspect/users/sip:user@example.com/aspectdef HTTP/1.1
Host xcap.example.com
......

S44: The Aspect XDMS parses the request message, and returns a 200 OK response message to the PAL client. The response message carries an XML document that includes definitions of all aspects defined by the user and stored on the Aspect XDMS. The response message is as shown below:

HTTP/1.1 200 OK
...
Etag: “ababab”
Content-Type:application/pal-aspect+xml
Content-Length: (...)
<?xml version=“1.0” encoding=“UTF-8”?>
<aspect-list xmlns=“urn:oma:xml:xdm:aspect-list>
<uri>sip:user@example.com</uri>
<aspect name=“......”>

<note>......</note>

<result id=“a”>

......

</result>

<result id=“b”>

......

</result>

<aspect>
<aspect name=“......”>

.......

</aspect>
<aspect name=“......”>

.......

</aspect>

......
</aspect-list>

S45: After the user views all existing aspects, because no existing aspect meets the current requirement, the user sends an HTTP PUT command as a CREATE request to the Aspect XDMS, requesting to create a new aspect based on the existing aspect 1 and aspect 2. The request message is as shown below:

PUT/pal-aspect/users/sip:user@example.com/aspectdef

/~~/aspect-list/aspect%5b@name=%22PoC-session%22%5d/aspect%5b@name=%22nestsing
-aspect%22%5d HTTP/1.1

Host: xcap.example.com
...
Content-Type: application/xcap-el+xml
Content-Length: (...)
<aspect name=“nesting-aspect”>

<note>This aspect is used to indicate......</note>

<result id=“a”>

<sub_aspect name=“aspect1”>

......

</sub_aspect>
<sub_aspect name=“aspect2”>

......

</sub_aspect>
<value>......</value>

</result>
......

</aspect>

S46: The Aspect XDMS parses the request, adds the new user-defined aspect to the corresponding location of the definition document, and returns a 200 OK response message to the PAL client to confirm success of adding. The response message is as shown below:

HTTP/1.1 200 OK
Etag: “efefefef”

In this embodiment, the Aspect XDMS may perform the corresponding action as requested by the user, and return a corresponding response message, so that the user can manage the stored aspect and/or aspect trigger information conveniently, the user experience is improved, and the load on the client is relieved.

In another embodiment of the present invention, the apparatus for managing an aspect and an aspect trigger may receive a sharing request. The sharing request includes sharing setting information of the aspect and/or the aspect trigger needed to be shared. The apparatus for managing an aspect and an aspect trigger adds, according to the sharing request, an element indicating the sharing setting information to a document that includes the definition of the aspect and/or aspect trigger, or creates a document that includes the sharing setting information of the aspect and/or aspect trigger.

Specifically, the sharing request may be sent by a PAL client or PAL server. That is, the PAL user may share the user-defined aspect and/or aspect trigger to another specific PAL user. The sharing request needs to specify the storage path of the definition document of the aspect and/or aspect trigger needed to be shared, and specify a contributor. The following is an example of codes of a sharing request message:

PUT/pal-aspect/users/sip:user@example.com/aspectdef/~~/aspect-list/

aspect%5b@name=%22PoC-session%22%5d/share

Host: xcap.example.com
...
Content-Type: application/xcap-el+xml
Content-Length: (...)
<share>

<active>true</active>
<share-list>

<entry>sip:friend1@example.com</entry>
<entry>sip:friend2@example.com</entry>

</share-list>

</share>

The foregoing message indicates that the “PoC-session” aspect of the user is shared to sip:friend1@example.com and sip:friend2@example.com.

After receiving the sharing request, the apparatus for managing an aspect and an aspect trigger parses the sharing request, and then performs either of the following operations: (1) The apparatus for managing an aspect and an aspect trigger finds the definition document of the aspect and/or aspect trigger needed to be shared, and adds the sharing setting information carried in the sharing request to the definition document. In this case, no new document needs to be created for recording the sharing information. The following is an example of the content of an aspect definition document that includes the sharing setting information:

<aspect name=“name1”>
<note>This aspect is used to indicate......</note>
<result id=“a”>

......

</result>
......
<share>

<active>true</active>
<share-list>

<entry>......</entry>
......
</share-list>

</share>

</aspect>

In the preceding example, the <share> element represents the sharing setting of the aspect; and the <active> element indicates whether to share the element, and its value is “true” indicating sharing, or “false” indicating not sharing.

(2) A special document is created for recording the sharing setting information of the aspect and/or aspect trigger, and is stored. This document serves the only purpose of recording the sharing setting of the aspect or aspect trigger defined by each PAL user. The following is an exemplary format of the document:

<?xml version=“1.0” encoding=“UTF-8”?>
<share-setting xmlns=“urn:oma:xml:xdm:share-setting>
<uri>sip:user@example.com</uri>
<aspect name=“......”>

<share-list>

<entry>sip:friend1@example.com<entry>
<entry>sip:friend2@example.com<entry>

</share-list>

</aspect>
<aspect name=“......”>

......

</aspect>
......
</share-setting>

In the preceding example, the <share-setting> element represents the sharing setting, and its subelement <uri > is an identity of the PAL user that performs the setting; <aspect> represents the shared aspect, and its subelement <share-list> is a list of PAL users to whom the aspect definition is shared.

In this mode, the PAL user may manage, through the PAL client, the sharing setting information in the aspect and the aspect trigger through a PUT request, a GET request, or a DELETE request in the same way as managing the definition document. The apparatus for managing an aspect and an aspect trigger processes such requests in the same way as processing the definition document described above accordingly, which is not repeatedly described here.

Further, the PAL server may actively request the apparatus for managing an aspect and an aspect trigger to add the shared definition to the user-defined information document of the recipient.

Before requesting the apparatus for managing an aspect and an aspect trigger to add the shared aspect definition, the PAL server may send a notification to the recipient. The notification should include an identifier of the contributor and the shared definition of the aspect and/or aspect trigger. After the recipient accepts the sharing, the PAL server requests the apparatus for managing an aspect and an aspect trigger to add the sharing information to the user-defined information document of the recipient, and use a specific element to identify the information related to the sharing information. After receiving the request, the apparatus for managing an aspect and an aspect trigger adds the sharing information to the user-defined document of the recipient. Specifically, a document that includes the added sharing information may be expressed as follows:

<?xml version=“1.0” encoding=“UTF-8”?>
<aspect-list xmlns=“urn:oma:xml:xdm:aspect-list>
<aspect name=“......”>

......
<aspect>
<aspect name=“......”>

.......

</aspect>

......(the foregoing is the user-defined aspect of the recipient)

<aspect name=“......”>

.......
<shared>

<from>......</from>
......

</shared>

</aspect>

......(the foregoing is the aspect definition shared by others to
the recipient)
</aspect-list>
<shared> represents the shared information, and its subelement

<from> represents the contributor of the aspect, namely, the party
who shares the aspect to the recipient.

In addition, the PAL user may also check which aspects have been shared to others by the PAL user, and which aspects have been shared to the PAL user by others so far. In this example, specifically, the apparatus for managing an aspect and an aspect trigger is an Aspect XDMS.

The PAL user may send an HTTP GET command as a sharing request to the Aspect XDMS to obtain aspects of the PAL user that have been shared to others.

As mentioned above, if the setting of the user-defined aspect shared by a user to others is recorded in a dedicated XML document, the following is an example of the request message for obtaining aspects of the user that have been shared to others:

GET/pal-aspect/users/sip:user@example.com/share-setting HTTP/1.1
Host xcap.example.com

After receiving the sharing request message, the Aspect XDMS parses the request message, and returns a response message to the PAL user. The following is an example of the response message:

HTTP/1.1 200 OK
...
Etag: “ababab”
Content-Type:application/share-setting+xml
Content-Length: (...)
<?xml version=“1.0” encoding=“UTF-8”?>
<share-setting xmlns=“urn:oma:xml:xdm:share-setting>
<uri>sip:user@example.com</uri>
<aspect name=“name1”>

<share-list>

<entry>sip:friend1@example.com<entry>
<entry>sip:friend2@example.com<entry>

</share-list>

</aspect>
<aspect name=“name2”>

<share-list>

<entry>sip:friend3@example.com<entry>
<entry>sip:friend4@example.com<entry>

</share-list>

</aspect>
......
</share-setting>

The response message indicates that: The aspect identified by name1 is shared to friend1@example.com and friend2@example.com; the aspect identified by name2 is shared to friend3@example.com and friend4@example.com. If the PAL user needs to view aspect information that has been shared by others to the PAL user, the PAL user may send an HTTP POST command to the Aspect XDMS as a request message to obtain the information. The following is an example of codes of the request message:

POST

/org.openmobilealliance.search?target=org.openmobilealliance.pal-aspect/users/sip:user@exa
mple.com/aspectdef HTTP/1.1

Host: xcap.example.com
User-Agent: XDM-client/OMA2.0
Date: Thu, 10 Aug 2006 10:50:33 GMT
X-3GPP-Intended-Identity: “sip:user@example.com”
Accept-Encoding: gzip
Content-Type: application/vnd.oma.search+xml
Content-Length: ...
<?xml version=“1.0” encoding=“UTF-8”?>
<search-set xmlns=“urn:oma:xml:xdm:search”>
<search id=“1234”>

<request>

<query>

<![CDATA[

xquery version “1.0”;

declare default element namespace

“urn:oma:xml:xdm:pal-aspect”;

for $u in in collection
(“org.openmobilealliance. pal-aspect/users/
sip:user@example.com/aspectdef/”)
/aspect-list/aspect

Where

(exists($u/shared)(--indicates that the returned aspect element includes a

<shared> subelement, and indicates the aspect information shared by others to the user--)

return $u

]]>

</query>

</request>

</search>
<search-set>

After receiving the request message, the apparatus for managing an aspect and an aspect trigger parses the request message, and then returns a response message to the requester. The response message carries the information about the aspects shared by others to the user.

In this embodiment, the apparatus for managing an aspect and an aspect trigger enables the PAL user to share the definition of the user-defined aspect and/or aspect trigger to other specified PAL users, and therefore, the PAL user does not need to define the same aspect and/or aspect trigger repeatedly, and the user can use the service more flexibly and conveniently.

In another embodiment of the present invention, the apparatus for managing an aspect and an aspect trigger may receive a search request that carries a search condition, search for the information about the aspect and/or the aspect trigger meeting the search condition, and return the information to the requester.

Specifically, the PAL client may search for information about the aspect and/or the aspect trigger of a specific type through an XCAP POST search request. The search request may specify the search condition such as searching according to the function type and keyword. The following is an example of the search request:

POST

/org.openmobilealliance.search?target=org.openmobilealliance.pal-aspect/users/
sip:user@example.com/triggerdef HTTP/1.1

Host: xcap.example.com
User-Agent: XDM-client/OMA2.0
Date: Thu, 10 Aug 2006 10:50:33 GMT
X-3GPP-Intended-Identity: “sip:user@example.com”
Accept-Encoding: gzip
Content-Type: application/vnd.oma.search+xml
Content-Length: ...
<?xml version=“1.0” encoding=“UTF-8”?>
<search-set xmlns=“urn:oma:xml:xdm:search”>
<search id=“1234”>

<request>

<query>

<![CDATA[

xquery version “1.0”;

declare default element namespace

“urn:oma:xml:xdm:pal-aspect”;

for $u in in collection
(“org.openmobilealliance.pal-aspect/users/
sip:user@example.com/triggerdef/”)
/trigger-list/aspect-trigger(--indicates that the set search scope is the aspect trigger

definition documents of the user--)

Where

(contains($u/action/service,IM)and(exists($u/condition/loc-element))(--indicates that the returned aspect-trigger definitions need to be related to both the IM service and the location information--)

return $u(--indicates that the definitions of the aspect triggers of the user identified by sip:user@example.com are returned--)

```
  ]]>
    </query>
  </request>
</search>
<search-set>
```

where: the <search> element indicates that the message is a search request, and the <query> element represents the search condition to be fulfilled.

After receiving the POST command, the apparatus for managing an aspect and an aspect trigger such as the Aspect XDMS checks whether the search document in the message body fulfills the specified format, and checks whether the <query> element in the search document fulfills the constraint (which is specified by the application corresponding to the XDMS). If the specified format and the constraint are fulfilled, the apparatus for managing an aspect and an aspect trigger searches for information that meets the search condition within the scope specified by the <query> element, and returns search results to the PAL client. In the foregoing example, the apparatus for managing an aspect and an aspect trigger returns the aspect trigger definitions meeting the search condition to the PAL client. If either condition is not fulfilled, the apparatus for managing an aspect and an aspect trigger returns an error response to the PAL client.

In this embodiment, the apparatus for managing an aspect and an aspect trigger may receive the search request, and return the information about the aspect and/or the aspect trigger meeting the search condition to the PAL client. Therefore, the PAL client does not need to store definitions of the aspect and/or the aspect trigger, and can use the definitions more conveniently and quickly; the load on the PAL client is relieved, and the user experience is improved.

The foregoing embodiments may be implemented separately or implemented together. That is, so long as the apparatus for managing an aspect and an aspect trigger stores the definitions of the aspect and/or the aspect trigger, any one or combination of the following operations can be performed on the stored definitions of the aspect and/or the aspect trigger: modified, deleted, obtained, added, shared, or searched out.

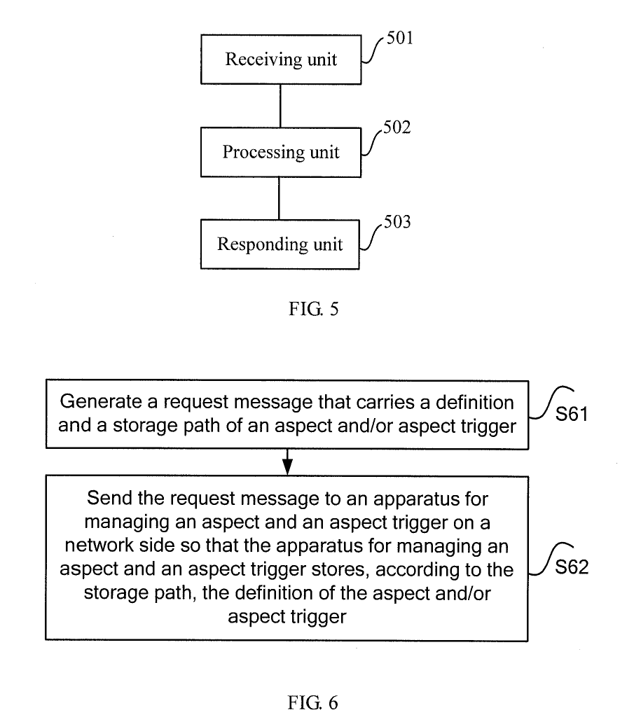

FIG. 5 is a schematic structural diagram of an apparatus for managing an aspect and an aspect trigger according to an embodiment of the present invention. The apparatus includes a receiving unit 501 and a processing unit 502.

The receiving unit 501 is configured to receive a request message that carries a definition and a storage path of an aspect and/or aspect trigger, where the aspect is an abstraction of one or more information elements or represents one or more types of information elements needed to be obtained, and the aspect trigger represents to perform a corresponding trigger action when a specific aspect fulfills a preset condition.

For detailed implementation, see the description in step S11, which is not repeatedly described here.

The processing unit 502 is configured to parse the request message, and create, according to the storage path, a document that includes the definition of the aspect and/or aspect trigger.

For detailed implementation, see the description in step S12, which is not repeatedly described here.

It should be noted that, the apparatus for managing an aspect and an aspect trigger may be a separate physical entity, or may be integrated in the PAL server physically.

In this embodiment, the apparatus for managing an aspect and an aspect trigger may parse the request message sent by the PAL client or PAL server, and store the definition of the aspect and/or aspect trigger carried in the request message in the form of a document. Therefore, when the PAL client sends a request to the PAL server, the request does not need to carry the stored definition of the aspect and/or aspect trigger, which relieves the load on the PAL client.

Optionally, the receiving unit 501 is further configured to receive a MODIFY request, and the processing unit 502 is further configured to:

find the corresponding document according to the MODIFY request, and modify the definition of the aspect and/or aspect trigger included in the document; and/or

the receiving unit 501 is further configured to receive a DELETE request, and the processing unit 502 is further configured to:

find the corresponding document according to the DELETE request, and delete the definition of the aspect and/or aspect trigger included in the document; and/or

the receiving unit 501 is further configured to receive a GET request, and the processing unit 502 is further configured to:

find the corresponding document according to the GET request, and send the definition of the aspect and/or aspect trigger included in the document to the requester; and/or

the receiving unit 501 is further configured to receive a CREATE request that carries a new element and/or new attribute, and the processing unit 502 is further configured to:

add the new element and/or new attribute to the document according to the CREATE request.

The receiving unit 501 is further configured to receive a sharing request that carries the sharing setting information of the aspect and/or aspect trigger needed to be shared.

The processing unit 502 is further configured to: add, according to the sharing request, an element indicating the sharing setting information to the document that includes, the definition of the aspect and/or aspect trigger; and/or create, according to the sharing request, a document that includes the sharing setting information of the aspect and/or aspect trigger.

The receiving unit 501 is further configured to receive a search request, and the processing unit 502 is further configured to search for information about the aspect and/or the aspect trigger meeting the search condition, and return the information to the requester.

For the detailed implementation of functions of the receiving unit 501 and the processing unit 502, see the corresponding part in the preceding method embodiments, which is not repeatedly described here.

In addition, the apparatus for managing an aspect and an aspect trigger may further include a responding unit 503, configured to return a response message to the requester. Specifically, after completion of the operation such as modification, deletion, or addition of a new element or new attribute, the apparatus for managing an aspect and an aspect trigger may return a response message to the requester. The content of the response message has been described in the embodiments shown in FIG. 1 to FIG. 4, and is not be repeatedly described here.

In this embodiment, the apparatus for managing an aspect and an aspect trigger supports modification and deletion of the document stored in the apparatus with respect to the definition of the aspect and/or aspect trigger, supports creation of a new attribute or element, and sends the definition of the aspect and/or aspect trigger to the requester. Therefore, the PAL server or PAL client may manage and use the definition of the aspect and/or aspect trigger flexibly and conveniently, which relieves the load on the client.

FIG. 6 is a flowchart of another method for managing an aspect and an aspect trigger according to an embodiment of the present invention. The method includes the following steps:

S61: Generate a request message that includes a definition and a storage path of an aspect and/or aspect trigger.

This operation may be performed by a PAL server or PAL client.

The PAL server may create the definition of the aspect and/or aspect trigger, or receive the definition of the aspect and/or aspect trigger from the client. The definition of the aspect and/or aspect trigger from the client may be carried in a service request. After creating the definition of the aspect and/or aspect trigger or receiving the definition of the aspect and/or aspect trigger from the client, the PAL server generates a request message that specifies the storage path of the definition of the aspect and/or aspect trigger. For the detailed content of the request message, see the description in step S11, which is not be repeatedly described here.

S62: Send the request message to an apparatus for managing an aspect and an aspect trigger on a network side so that the apparatus for managing aspects and aspect trigger stores, according to the storage path, the definition of the aspect and/or aspect trigger.

Specifically, the PAL server or PAL client may send the request message in the form of an XCAP PUT request.

After receiving the request message, the apparatus for managing an aspect and an aspect trigger creates a document that includes the definition of the aspect and/or aspect trigger in the storage path specified in the request message. For detailed implementation, see the description in the embodiment shown in FIG. 1, which is not be repeatedly described here.

With the method for managing an aspect and an aspect trigger provided in this embodiment, the PAL server or PAL client stores the definition of the aspect and/or aspect trigger carried in the request message to the apparatus for managing an aspect and an aspect trigger on the network side, so that the PAL client can use the PAL service more conveniently and that the load on the PAL client can be relieved.

In an embodiment of the present invention, the PAL client or PAL server may also request the apparatus for managing an aspect and an aspect trigger to delete or modify the definition of an aspect and/or aspect trigger, or to add a new element and/or new attribute to the definition of an aspect and/or aspect trigger. Specifically, the PAL server sends an XCAP DELETE request to the apparatus for managing an aspect and an aspect trigger to delete the definition of an aspect and/or aspect trigger; or sends an XCAP PUT request to the apparatus for managing an aspect and an aspect trigger to modify the stored definition of an aspect and/or aspect trigger, and add a new element and/or new attribute to the definition of the aspect and/or aspect trigger.

For the detailed process of the PAL server or PAL client performing the foregoing operation and the detailed codes of the request messages, see the description in the embodiments shown in FIG. 1 to FIG. 4, which are not repeatedly described here.

In this embodiment of the present invention, the PAL client or PAL server modifies or deletes the definition of an aspect and/or aspect trigger stored in the apparatus for managing an aspect and an aspect trigger, or adds a new element or new attribute to the definition of an aspect and/or aspect trigger stored in the apparatus for managing an aspect and an aspect trigger, which facilitates the using, by the PAL client, of the PAL service, and relieves the load on the PAL client.

In another embodiment of the present invention, when it is necessary to use the definition of an aspect and/or aspect trigger, the PAL client or PAL server may send an XCAP GET request to obtain the definition of an aspect and/or aspect trigger stored in the apparatus for managing an aspect and an aspect trigger. For the detailed content of the request message, see the description in the embodiment shown in FIG. 4, which is not repeatedly described here.

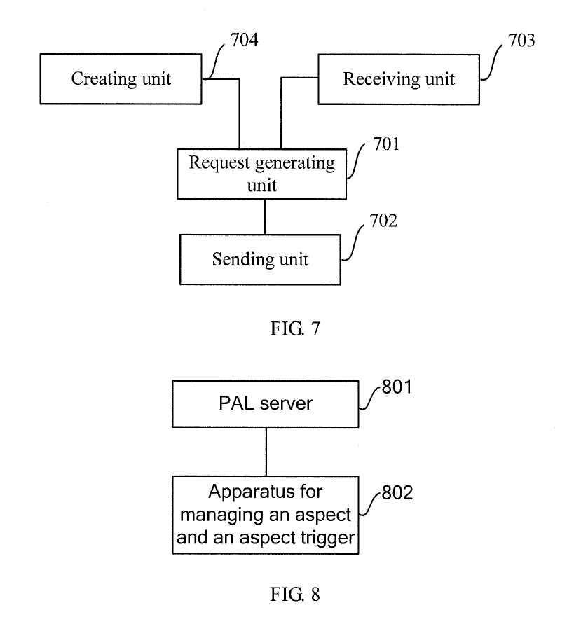

FIG. 7 is a schematic structural diagram of an apparatus for processing an aspect and an aspect trigger according to an embodiment of the present invention. The apparatus includes a request generating unit 701 and a sending unit 702.

The request generating unit 701 is configured to generate a request message that includes a definition and a storage path of an aspect and/or aspect trigger.

For the detailed implementation process, see the description in step S61.

The sending unit 702 is configured to send the request message to an apparatus for managing an aspect and an aspect trigger on a network side so that the apparatus for managing an aspect and an aspect trigger stores, according to the storage path, the definition of the aspect and/or aspect trigger.

For the detailed implementation process, see the description in step S62.

Optionally, the request generating unit 701 is further configured to generate a DELETE request, requesting the apparatus for managing an aspect and an aspect trigger to delete the definition of an aspect and/or aspect trigger; and the sending unit 702 is further configured to send the DELETE request; and/or

the request generating unit 701 is further configured to generate a MODIFY request, requesting the apparatus for managing an aspect and an aspect trigger to modify the definition of an aspect and/or aspect trigger; and the sending unit 702 is further configured to send the MODIFY request; and/or

the request generating unit 701 is further configured to generate a CREATE request, requesting the apparatus for managing an aspect and an aspect trigger to add a new element and/or new attribute to the definition of an aspect and/or aspect trigger; and the sending unit 702 is further configured to send the CREATE request; and/or

the request generating unit 701 is further configured to generate a GET request, requesting to obtain a definition of an aspect and/or aspect trigger from the apparatus for managing an aspect and an aspect trigger; and the sending unit 702 is further configured to send the GET request.

For detailed implementation, see the description in the embodiments shown in FIG. 1 to FIG. 4, which is not repeatedly described here.

Optionally, the apparatus shown in FIG. 7 may further include: a receiving unit 703, which is configured to receive a service request that carries the definition of an aspect and/or aspect trigger; and/or a creating unit 704, which is configured to create a definition of an aspect and/or aspect trigger.

The apparatus for processing an aspect and an aspect trigger provided in this embodiment may request the apparatus for managing an aspect and an aspect trigger to modify or delete the stored definition of an aspect and/or aspect trigger, so that the PAL client can use the PAL service more conveniently and that the load on the PAL client can be relieved.

FIG. 8 is a schematic structural diagram of a system for managing an aspect and an aspect trigger according to an embodiment of the present invention. The system includes:

a PAL server 801, configured to generate a request message that carries a definition and a storage path of an aspect and/or aspect trigger, and send the request message to an apparatus for managing an aspect and an aspect trigger on a network side so that the apparatus for managing an aspect and an aspect trigger stores, according to the storage path, the definition of the aspect and/or aspect trigger; and

the apparatus 802 for managing an aspect and an aspect trigger, configured to: receive the request message that carries the definition and the storage path of the aspect and/or aspect trigger, where the aspect is an abstraction of one or more information elements or represents an information element needed to be obtained, and the aspect trigger represents a corresponding trigger action to be performed when the aspect fulfills a trigger condition; and parse the request message, and create, according to the storage path, a document that includes the definition of the aspect and/or aspect trigger.

For detailed implementation of the foregoing apparatus, see the description in the foregoing embodiments, which is not repeatedly described here.

In the system for managing an aspect and an aspect trigger provided in this embodiment, the apparatus 802 for managing an aspect and an aspect trigger manages the definition of the aspect and/or aspect trigger, so that the PAL client can use the PAL service more conveniently and that the load on the PAL client can be relieved.

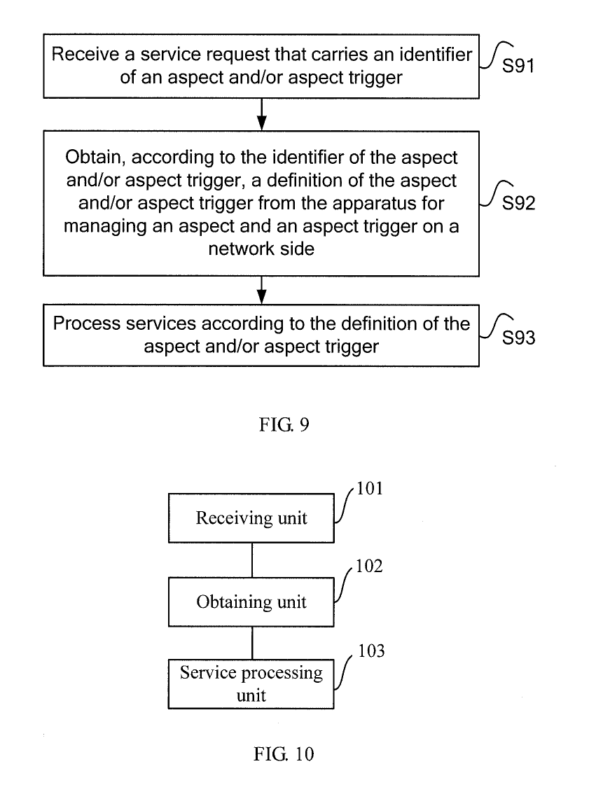

FIG. 9 is a flowchart of a service processing method according to an embodiment of the present invention. The method includes the following steps:

S91: Receive a service request that carries an identifier of an aspect and/or aspect trigger.

Specifically, a PAL server receives a service request sent by a PAL client. The service request may be a service trigger request or a subscription request. In the service request, the relevant information is indicated by the identifier of the aspect and/or aspect trigger. The identifier of the aspect and/or aspect trigger indicates the type of the aspect and/or aspect trigger, which is defined by a system or a user.

S92: Obtain, according to the identifier of the aspect and/or aspect trigger, the definition of the aspect and/or aspect trigger from the apparatus for managing an aspect and an aspect trigger on the network side.

After receiving the service request sent by the PAL client, the PAL server judges the storage path of the aspect and/or aspect trigger according to the identifier of the aspect and/or aspect trigger and the SIP URI of the user corresponding to the PAL client. Afterward, the PAL server sends a request message to an apparatus for managing an aspect and an aspect trigger, such as an Aspect XDMS, requesting to obtain the definition of the aspect and/or aspect trigger. The request message includes the storage path of the aspect and/or aspect trigger.

S93: Process services according to the definition of the aspect and/or aspect trigger.

After obtaining the definition of the aspect and/or aspect trigger, the PAL server may obtain the information about the definition of the aspect and/or aspect trigger from the corresponding server according to the definition of the aspect and/or aspect trigger. If the aspect and/or aspect trigger is related to presence information, the PAL server obtains the presence information from a presence information server; if the aspect and/or aspect trigger is related to the location information, the PAL server obtains the location information from a location server.

For the detailed implementation of this embodiment, see the embodiment shown in FIG. 2, which is not repeatedly described here.

With the service processing method provided in this embodiment, the definition of the aspect and/or aspect trigger may be obtained according to the identifier of the aspect and/or aspect trigger in the service request. Therefore, the service request sent by the PAL client does not need to carry the definition of the aspect and/or aspect trigger, so that the PAL client can use the PAL service more conveniently and that the load on the PAL client can be relieved.

FIG. 10 is a schematic structural diagram of a PAL server according to an embodiment of the present invention. The PAL server includes:

a receiving unit 101, configured to receive a service request that carries an identifier of an aspect and/or aspect trigger;

an obtaining unit 102, configured to obtain, according to the identifier of the aspect and/or aspect trigger, a definition of the aspect and/or aspect trigger from an apparatus for managing an aspect and an aspect trigger on a network side; and

a service processing unit 103, configured to process services according to the definition of the aspect and/or aspect trigger.

For detailed implementations of the foregoing units, see the description in the embodiments shown in FIG. 2 to FIG. 9, which are not repeatedly described here.

The PAL server provided in this embodiment may obtain the definition of the aspect and/or aspect trigger according to the identifier of the aspect and/or aspect trigger in the service request. Therefore, the service request sent by the PAL client does not need to carry the definition of the aspect and/or aspect trigger, so that the PAL client can use the PAL service more conveniently and that the load on the PAL client can be relieved.

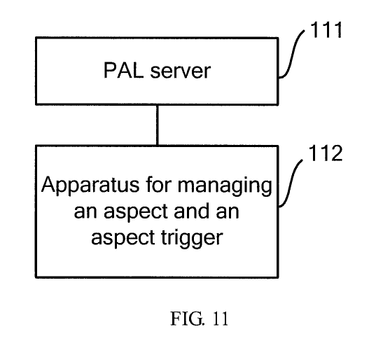

FIG. 11 is a schematic structural diagram of a service processing system according to an embodiment of the present invention. The system includes a PAL server 111 and an apparatus 112 for managing an aspect and an aspect trigger.

The PAL server 111 is configured to: receive a service request that carries an identifier of an aspect and/or aspect trigger; obtain, according to the identifier of the aspect and/or aspect trigger, a definition of the aspect and/or aspect trigger from an apparatus for managing an aspect and an aspect trigger on a network side; and process services according to the definition of the aspect and/or aspect trigger.

For detailed implementation, see the description in the embodiments shown in FIG. 2 and FIG. 9, which is not repeatedly described here.

The apparatus 112 for managing an aspect and an aspect trigger is configured to create a document that includes the definition of the aspect and/or aspect trigger.

For detailed implementation, see the description in the embodiment shown in FIG. 1, which is not repeatedly described here.

In the service processing system provided in this embodiment, the apparatus 112 for managing an aspect and an aspect trigger stores definitions of the aspect and/or the aspect trigger. When necessary, the PAL server 111 obtains, according to the identifier of the aspect and/or aspect trigger, the definition of the aspect and/or aspect trigger from the apparatus 112 for managing an aspect and an aspect trigger. Therefore, the service request sent by the PAL client does not need to carry the definition of the aspect and/or aspect trigger, which facilitates the using, by the PAL client, of the PAL service and relieves the load on the PAL client.

It should be noted that no stand-alone functional component needs to be introduced into the embodiments of the present invention, and that the present invention may be implemented through software in addition to a necessary universal hardware platform. Therefore, the essence of the technical solution of the present invention or contributions to the prior art may be embodied in a software product. The software product is stored in a computer-readable storage medium, and incorporates several instructions for instructing a device to execute the method specified in any embodiment of the present invention. The storage medium may be a Read Only Memory (ROM), a Random Access Memory (RAM), a magnetic disk, or a Compact Disk-Read Only Memory (CD-ROM).

The foregoing descriptions are merely exemplary embodiments of the present invention, but not intended to limit the scope of the present invention. Any modification, equivalent replacement, or improvement made without departing from the spirit and principles of the present invention shall fall within the scope of the present invention.

What is claimed is:

1. A method for managing an aspect and an aspect trigger, comprising:
receiving a request message that carries a definition and a storage path of an aspect or aspect trigger, wherein the aspect is an abstraction of one or more information elements or represents one or more types of information elements needed to be obtained, and the aspect trigger represents to perform a corresponding trigger action when a specific aspect fulfills a preset condition; and
parsing the request message, and creating, according to the storage path, a document that comprises the definition of the aspect or aspect trigger.

2. The method according to claim 1, wherein:
the definition of the aspect supports aspect nesting.

3. The method according to claim 1, further comprising at least one of the following steps:
receiving a MODIFY request, and modifying, according to the MODIFY request, the definition of the aspect or aspect trigger included in the document;
receiving a DELETE request, and deleting, according to the DELETE request, the definition of the aspect or aspect trigger included in the document;
receiving a GET request, and sending, according to the GET request, the definition of the aspect or aspect trigger included in the document to a requester; and
receiving a CREATE request that carries a new element or new attribute of the aspect or aspect trigger, and adding, according to the CREATE request, the new element or new attribute to the document.

4. The method according to claim 1, further comprising:
receiving a sharing request that carries sharing setting information of the aspect or aspect trigger needed to be shared; and
adding, according to the sharing request, an element indicating the sharing setting information to the document that comprises the definition of the aspect or aspect trigger, or creating a document that comprises the sharing setting information of the aspect or aspect trigger.

5. The method according to claim 1, further comprising:
receiving a search request that comprises a search condition;
searching for information about the aspect or aspect trigger meeting the search condition, and returning the information to a requester.

6. An apparatus for managing an aspect and an aspect trigger, comprising:
a receiving unit, configured to receive a request message that carries a definition and a storage path of an aspect or aspect trigger, wherein the aspect is an abstraction of one or more information elements or represents one or more types of information elements needed to be obtained, and the aspect trigger represents to perform a corresponding trigger action when a specific aspect fulfills a preset condition; and
a processing unit, configured to parse the request message, and create, according to the storage path, a document that comprises the definition of the aspect or aspect trigger.

7. The apparatus according to claim 6, wherein:
the receiving unit is further configured to receive a MODIFY request, and the processing unit is further configured to find a corresponding document according to the MODIFY request, and modify the definition of the aspect or aspect trigger in the document; or
the receiving unit is further configured to receive a DELETE request, and the processing unit is further configured to find a corresponding document according to the DELETE request, and delete the definition of the aspect or aspect trigger in the document; or
the receiving unit is further configured to receive a GET request, and the processing unit is further configured to find a corresponding document according to the GET request, and send the definition of the aspect or aspect trigger in the document to a requester; or
the receiving unit is further configured to receive a CREATE request that carries a new element or new attribute of the aspect or aspect trigger, and the processing unit is further configured to add the new element or new attribute to the document according to the CREATE request.

8. The apparatus according to claim 6, wherein:
the receiving unit is further configured to receive a sharing request that comprises sharing setting information of the aspect or aspect trigger needed to be shared; and
the processing unit is further configured to: add, according to the sharing request, an element indicating the sharing setting information to the document that comprises the definition of the aspect or aspect trigger; or create a document that comprises the sharing setting information of the aspect or aspect trigger.

9. The apparatus according to claim 6, wherein:
the receiving unit is further configured to receive a search request; and
the processing unit is further configured to search for information about the aspect or aspect trigger meeting the search condition, and return the information to a requester.

10. The apparatus according to claim 6, further comprising:
a responding unit, configured to return a response message to a sender of the request message.

11. A method for managing an aspect and an aspect trigger, comprising:
generating a request message that carries a definition and a storage path of an aspect or aspect trigger; and
sending the request message to an apparatus for managing an aspect and an aspect trigger on a network side so that the apparatus for managing an aspect and an aspect trigger stores, according to the storage path, the definition of the aspect or aspect trigger.

12. The method according to claim 11, further comprising:
requesting the apparatus for managing an aspect and an aspect trigger to delete or modify the definition of the aspect or aspect trigger, or to add a new element or new attribute to the definition of the aspect or aspect trigger.

13. The method according to claim 11, wherein:
the request message is sent in the form of an XML Configuration Access Protocol (XCAP) PUT request, wherein XML stands for Extensible Markup Language.

14. The method according to claim 12, wherein:
an XML Configuration Access Protocol (XCAP) DELETE request is sent to the apparatus for managing an aspect and an aspect trigger to delete the stored definition of the aspect or aspect trigger, wherein XML stands for Extensible Markup Language; and
an XCAP PUT request is sent to the apparatus for managing an aspect and an aspect trigger to modify the stored definition of the aspect or aspect trigger, or add a new element or new attribute to the definition of the aspect or aspect trigger.

15. The method according to claim 11, further comprising:
when it is necessary to use the definition of the aspect or aspect trigger, sending an XML Configuration Access Protocol (XCAP) GET request to obtain the definition of the aspect or aspect trigger stored in the apparatus for managing an aspect and an aspect trigger, wherein XML stands for Extensible Markup Language.

16. The method according to claim 11, wherein before generating the request message, the method further comprises:
receiving the definition of the aspect or aspect trigger; or creating the definition of the aspect or aspect trigger.

17. An apparatus for processing an aspect and an aspect trigger, comprising:
a request generating unit, configured to generate a request message that carries a definition and a storage path of an aspect or aspect trigger; and
a sending unit, configured to send the request message to an apparatus for managing an aspect and an aspect trigger on a network side so that the apparatus for managing an aspect and an aspect trigger stores, according to the storage path, the definition of the aspect or aspect trigger.

18. The apparatus according to claim 17, further comprising:
a receiving unit, configured to receive a service request that carries the definition of the aspect or aspect trigger; or
a creating unit, configured to create the definition of the aspect or aspect trigger.

19. The apparatus according to claim 17, wherein:
the request generating unit is further configured to generate a DELETE request, requesting the apparatus for managing an aspect and an aspect trigger to delete the definition of the aspect or aspect trigger; and the sending unit is further configured to send the DELETE request; or
the request generating unit is further configured to generate a MODIFY request, requesting the apparatus for managing an aspect and an aspect trigger to modify the definition of the aspect or aspect trigger; and the sending unit is further configured to send the MODIFY request; or
the request generating unit is further configured to generate a CREATE request, requesting the apparatus for managing an aspect and an aspect trigger to add a new element or new attribute to the definition of the aspect and/or aspect trigger; and the sending unit is further configured to send the CREATE request; or
the request generating unit is further configured to generate a GET request, requesting to obtain the definition of the aspect or aspect trigger from the apparatus for managing an aspect and an aspect trigger; and the sending unit is further configured to send the GET request.
